(19) United States
(12) Patent Application Publication
(10) Pub. No.: US 2024/0249133 A1
(43) Pub. Date: Jul. 25, 2024

(54) SYSTEMS, APPARATUSES, METHODS, AND NON-TRANSITORY COMPUTER-READABLE STORAGE DEVICES FOR TRAINING ARTIFICIAL-INTELLIGENCE MODELS USING ADAPTIVE DATA-SAMPLING

(71) Applicant: Huawei Technologies Co., Ltd., Shenzhen (CN)

(72) Inventors: Habib Hajimolahoseini, Toronto (CA); Ali Saheb Pasand, Waterloo (CA); Ehsan Kamalloo, Waterloo (CA); Mehdi Rezagholi Zadeh, Vaughan (CA); Yang Liu, Toronto (CA)

(21) Appl. No.: 18/099,364

(22) Filed: Jan. 20, 2023

(51) Int. Cl. G06N 3/08; G06F 18/15; G06F 18/211

(52) U.S. Cl. CPC G06N 3/08; G06F 18/15; G06F 18/211

(57) ABSTRACT

A method has the steps of: calculating importance metrics of a plurality of data samples based on predictions of an artificial-intelligence (AI) model obtained from the plurality of data samples in a plurality of previous training epochs without using labels of the plurality of data samples and without using a learning rate of the AI model; calculating sampling probabilities of the plurality of data samples based on the importance metrics thereof; selecting a subset of the plurality of data samples based on the sampling probabilities of the of plurality of data samples; and training the AI model using the selected subset of the plurality of data samples for one or more epochs.

### FIELD OF THE DISCLOSURE

The present disclosure relates generally to artificial-intelligence (AI) systems, apparatuses, methods, and non-transitory computer-readable storage devices, and in particular to AI systems, methods, and non-transitory computer-readable storage devices for training of AI models using adaptive data-sampling.

### BACKGROUND

Artificial-intelligence (AI) models such as deep learning models have become extensively large over the past a few years, with millions or even billions of trainable parameters. Training such huge models leads to a high memory consumption and computational complexity. Such models also need to be trained on massive datasets which may take a long time. These issues may cause limitations on training AI models on edge devices with limited computational power, and therefore their application in many scenarios becomes limited.

### SUMMARY

According to one aspect of this disclosure, there is provided a method comprising: (1) calculating importance metrics of a plurality of data samples based on predictions of an artificial-intelligence (AI) model obtained from the plurality of data samples in a plurality of previous training epochs; (2) calculating sampling probabilities of the plurality of data samples based on the importance metrics thereof; (3) selecting a subset of the plurality of data samples based on the sampling probabilities of the of plurality of data samples; and (4) training the AI model using the selected subset of the plurality of data samples for one or more epochs.

In some embodiments, the method further comprises: repeating steps (3) and (4); or repeating steps (1) to (4).

In some embodiments, the AI model is a deep-learning model; and said calculating the importance metrics of the plurality of data samples comprises: calculating the importance metric of each data sample of the plurality of data samples based on logits of the AI model obtained from the data sample in the plurality of previous training epochs.

In some embodiments, the importance metric of each data sample of the plurality of data samples is a 1-hop divergence or a M-hop divergence of the logits of the AI model obtained from the data sample in the plurality of previous training epochs.

In some embodiments, the sampling probability of each data sample is a normalized and shaped metric calculated from the importance metric of the data sample and shaped using a shaping function.

In some embodiments, the shaping function is a sharpness-controlling factor or a softmax function.

In some embodiments, the importance metric of each data sample is an entropy of the predictions of the AI model obtained from the data sample in the plurality of previous training epochs.

In some embodiments, the method further comprises: (5) training the AI model using the plurality of data samples for one or more training epochs; and after step (5), repeating steps (1) to (4).

According to one aspect of this disclosure, there is provided a system or one or more processors for executing the above-described method.

According to one aspect of this disclosure, there is provided one or more non-transitory computer-readable storage devices comprising computer-executable instructions, wherein the instructions, when executed, cause a processing structure to perform the above-described method.

The above-described systems, methods, and non-transitory computer-readable storage devices have various benefits such as:
No pre-training stage is required, and therefore, the total training time may be significantly saved compared to prior-art dataset-condensation methods. Moreover, since the subset of the plurality of data samples are selected before each epoch, the AI-model training in each epoch is accelerated.
No data sample is removed, and all data samples of the training dataset have their chances to contribute to the training (but with different probability of being chosen).
The importance metrics are not task specific or hand-crafted, and may be used for training of any AI models.
The importance metrics and accordingly the sampling probabilities of data samples may be repeated updated during AI-model training as the model, thereby providing more accurate training over time.
No auxiliary network is used for calculating the importance metric. The above-described systems, methods, and non-transitory computer-readable storage devices only use the difference between the outputs of the same model between consecutive epochs to measure the importance of the data samples.
above-described systems, methods, and non-transitory computer-readable storage devices may be used for any suitable type of tasks including Computer Vision (CV) and NLP as the above-described data-efficient training does not generate new samples by using gradient and other synthesizing methods.
The calculated metrics and the size of the subset of the plurality of data samples may be updated during training which may lead to a more accurate and flexible sampling in the next epochs, thereby providing more flexibility to perform well in different scenarios.

### BRIEF DESCRIPTION OF THE DRAWINGS

For a more complete understanding of the disclosure, reference is made to the following description and accompanying drawings, in which:

FIG. 1 is a simplified schematic diagram of an artificial intelligence (AI) system according to some embodiments of this disclosure;

FIG. 2 is a schematic diagram showing the hardware structure of the infrastructure layer of the AI system shown in FIG. 1, according to some embodiments of this disclosure;

FIG. 3 is a schematic diagram showing the hardware structure of a chip of the AI system shown in FIG. 1, according to some embodiments of this disclosure;

FIG. 4 is a schematic diagram of an AI model in the form of a deep neural network (DNN) used in the infrastructure layer shown in FIG. 2;

FIG. 5 is a flowchart showing the steps of a data-efficient training procedure performed by one or more processors of the AI system shown in FIG. 2, according to some embodiments of this disclosure;

FIG. 6 is a schematic diagram showing an example of the data-efficient training procedure shown in FIG. 5 for training a deep-learning model that uses a logit function for prediction;

FIG. 7 is a plot showing the experiment results of the data-efficient training method shown in FIG. 5 applied to a language model to test the effect of the data-efficient training on fine-tuning it on five different downstream tasks;

FIG. 8 is a flowchart showing the steps of a data-efficient training procedure performed by one or more processors of the AI system shown in FIG. 2, according to some other embodiments of this disclosure; and

FIG. 9 is a flowchart showing the steps of a data-efficient training procedure performed by one or more processors of the AI system shown in FIG. 2, according to yet some other embodiments of this disclosure.

### DETAILED DESCRIPTION

### A. Artificial-Intelligence System

Artificial intelligence (AI) machines and systems usually comprise one or more AI models which may be trained using a large amount of relevant data for improving the precision of their perception, inference, and decision making.

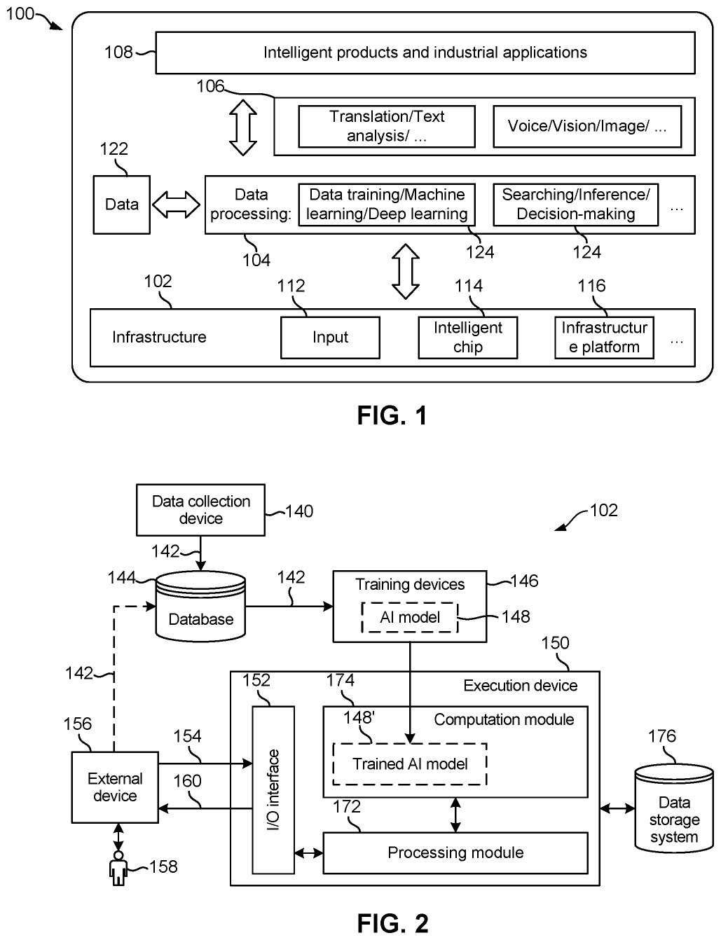

Turning now to FIG. 1, an AI system for data-clone detection according to some embodiments of this disclosure is shown and is generally identified using reference numeral 100. The AI system 100 comprises an infrastructure layer 102 for providing hardware basis of the AI system 100, a data processing layer 104 for processing relevant data and providing various functionalities 106 as needed and/or implemented, and an application layer 108 for providing intelligent products and industrial applications.

The infrastructure layer 102 comprises necessary input components 112 such as sensors and/or other input devices for collecting input data, computational components 114 such as one or more intelligent chips, circuitries, and/or integrated chips (ICs), and/or the like for conducting necessary computations, and a suitable infrastructure platform 116 for AI tasks.

The one or more computational components 114 may be one or more central processing units (CPUs), one or more neural processing units (NPUs; which are processing units having specialized circuits for AI-related computations and logics), one or more graphic processing units (GPUs), one or more application-specific integrated circuits (ASICs), one or more field-programmable gate arrays (FPGAs), and/or the like, and may comprise necessary circuits for hardware acceleration.

The platform 116 may be a distributed computation framework with networking support, and may comprise cloud storage and computation, an interconnection network, and the like.

In FIG. 1, the data collected by the input components 112 are conceptually represented by the data-source block 122 which may comprise any suitable data such as sensor data (for example, data collected by Internet-of-Things (IOT) devices), service data, perception data (for example, forces, offsets, liquid levels, temperatures, humidities, and/or the like), and/or the like, and may be in any suitable forms such as figures, images, voice clips, video clips, text, and/or the like.

The data processing layer 104 comprises one or more programs and/or program modules 124 in the form of software, firmware, and/or hardware circuits for processing the data of the data-source block 122 for various purposes such as data training, machine learning, deep learning, searching, inference, decision making, and/or the like.

In machine learning and deep learning, symbolic and formalized intelligent information modeling, extraction, preprocessing, training, and the like may be performed on the data-source block 122.

Inference refers to a process of simulating an intelligent inference manner of a human being in a computer or an intelligent system, to perform machine thinking and resolve a problem by using formalized information based on an inference control policy. Typical functions are searching and matching.

Decision making refers to a process of making a decision after inference is performed on intelligent information. Generally, functions such as classification, sorting, and inferencing (or prediction) are provided.

With the programs and/or program modules 124, the data processing layer 104 generally provides various functionalities 106 such as translation, text analysis, computer-vision processing, voice recognition, image recognition, and/or the like.

With the functionalities 106, the AI system 100 may provide various intelligent products and industrial applications 108 in various fields, which may be packages of overall AI solutions for productizing intelligent information decisions and implementing applications. Examples of the application fields of the intelligent products and industrial applications may be intelligent manufacturing, intelligent transportation, intelligent home, intelligent healthcare, intelligent security, automated driving, safe city, intelligent terminal, and the like.

FIG. 2 is a schematic diagram showing the hardware structure of the infrastructure layer 102, according to some embodiments of this disclosure. As shown, the infrastructure layer 102 comprises a data collection device 140 for collecting training data 142 for training an AI model 148 (such as a machine-learning (ML) model, a neural network (NN) model (for example, a convolutional neural network (CNN) model), or the like) and storing the collected training data 142 into a training database 144. Herein, the training data 142 comprises a plurality of identified, annotated, or otherwise classified data samples that may be used for training (denoted “training samples” hereinafter) and their corresponding desired results (denoted “labels” hereinafter; that is, the target or desired predictions that the AI model 148 should make from the data samples). Herein the training samples may be any suitable data samples to be used for training the AI model 148, such as one or more annotated images, one or more annotated text samples, one or more annotated audio clips, one or more annotated video clips, one or more annotated numerical data samples, and/or the like. The desired results are ideal results expected to be obtained by processing the training samples by using the trained or optimized AI model 148′. One or more training devices 146 (such as one or more server computers forming the so-called “computer cloud” or simply the “cloud”, and/or one or more client computing devices (also called “edge devices”) similar to or same as the execution devices 150) train the AI model 148 using the training data 142 retrieved from the training database 144 to train the AI model 148 for use by the computation module 174 (described in more detail later).

As those skilled in the art will appreciate, in actual applications, the training data 142 maintained in the training database 144 may not necessarily be all collected by the data collection device 140, and may be received from other devices. Moreover, the training devices 146 may not necessarily perform training completely based on the training data 142 maintained in the training database 144 to obtain the trained AI model 148′, and may obtain training data 142 from a cloud or another place to perform model training.

The trained AI model 148′ obtained by the training devices 146 through training may be applied to various systems or devices such as an execution device 150 which may be an edge device such as a mobile phone terminal, a tablet computer, a notebook computer, an augmented reality (AR) device, a virtual reality (VR) device, a vehicle-mounted terminal, a server, or the like. The execution device 150 comprises an I/O interface 152 for receiving input data 154 from an external device 156 (such as input data provided by a user 158) and/or outputting results 160 to the external device 156. The external device 156 may also provide training data 142 to the training database 144. The execution device 150 may also use its I/O interface 152 for receiving input data 154 directly from the user 158.

The execution device 150 also comprises a processing module 172 for performing preprocessing based on the input data 154 received by the I/O interface 152. For example, in cases where the input data 154 comprises one or more images, the processing module 172 may perform image preprocessing such as image filtering, image enhancement, image smoothing, image restoration, and/or the like.

The processed data 142 is then sent to a computation module 174 which uses the trained AI model 148′ to analyze the data received from the processing module 172 for prediction. As described above, the prediction results 160 may be output to the external device 156 via the I/O interface 152. Moreover, data 154 received by the execution device 150 and the prediction results 160 generated by the execution device 150 may be stored in a data storage system 176.

In the following, the AI model to be trained and the corresponding trained AI model are identified using the same reference numeral 148 for ease of description.

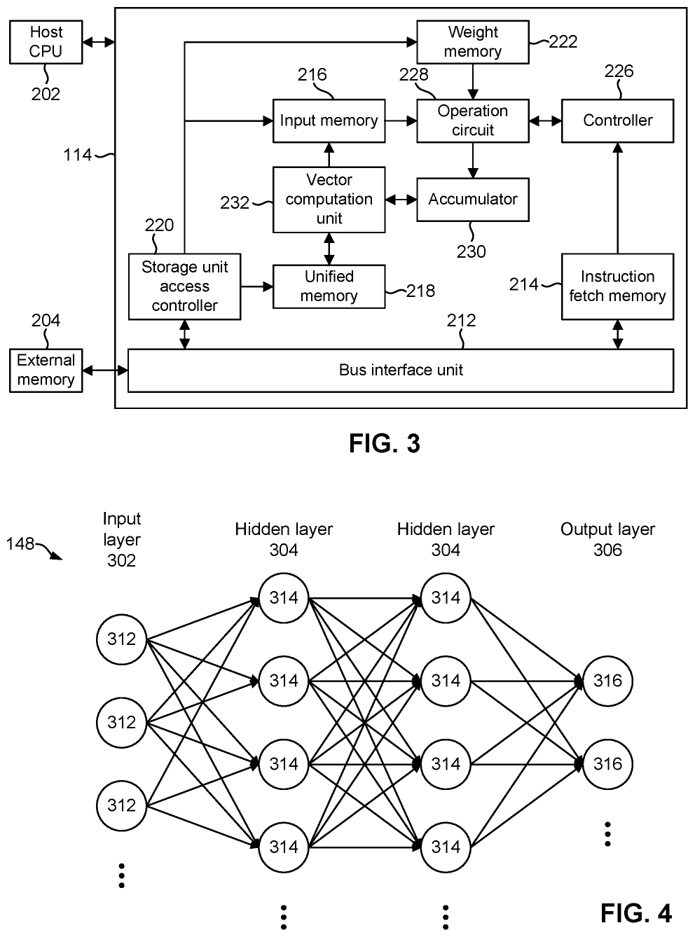

FIG. 3 is a schematic diagram showing the hardware structure of a computational component 114 according to some embodiments of this disclosure. The computational component 114 may be any processor suitable for large-scale exclusive OR operation processing, for example, a convolutional NPU, a tensor processing unit (TPU), a GPU, or the like. The computational component 114 may be a part of the execution device 150 coupled to a host CPU 202 for use as the computational module 160 under the control of the host CPU 202. Alternatively, the computational component 114 may be in the training devices 146 to complete training work thereof and output the trained AI model 148.

As shown in FIG. 3, the computational component 114 is coupled to an external memory 204 via a bus interface unit (BIU) 212 for obtaining instructions and data (such as the input data 154 and weight data) therefrom. The instructions are transferred to an instruction fetch buffer 214. The input data 154 is transferred to an input memory 216 and a unified memory 218 via a storage-unit access controller (or a direct memory access controller, DMAC) 220, and the weight data is transferred to a weight memory 222 via the DMAC 220. In these embodiments, the instruction fetch buffer 214, the input memory 216, the unified memory 218, and the weight memory 222 are on-chip memories, and the input data 154 and the weight data may be organized in matrix forms (denoted “input matrix” and “weight matrix”, respectively).

A controller 226 obtains the instructions from the instruction fetch buffer 214 and accordingly controls an operation circuit 228 to perform multiplications and additions using the input matrix from the input memory 216 and the weight matrix from the weight memory 222.

In some implementations, the operation circuit 228 comprises a plurality of processing engines (PEs; not shown). In some implementations, the operation circuit 228 is a two-dimensional systolic array. The operation circuit 228 may alternatively be a one-dimensional systolic array or another electronic circuit that may perform mathematical operations such as multiplication and addition. In some implementations, the operation circuit 228 is a general-purpose matrix processor.

For example, the operation circuit 228 may obtain an input matrix A (for example, a matrix representing an input image) from the input memory 216 and a weight matrix B (for example, a convolution kernel) from the weight memory 222, buffer the weight matrix B on each PE of the operation circuit 228, and then perform a matrix operation on the input matrix A and the weight matrix B. The partial or final computation result obtained by the operation circuit 228 is stored into an accumulator 230.

If required, the output of the operation circuit 228 stored in the accumulator 230 may be further processed by a vector calculation unit 232 such as vector multiplication, vector addition, an exponential operation, a logarithmic operation, size comparison, and/or the like. The vector calculation unit 232 may comprise a plurality of operation processing engines, and is mainly used for calculation at a non-convolutional layer or a fully connected layer (FC) of the convolutional neural network, and may specifically perform calculation in pooling, normalization, and the like. For example, the vector calculation unit 232 may apply a non-linear function to the output of the operation circuit 228, for example a vector of an accumulated value, to generate an active value. In some implementations, the vector calculation unit 232 generates a normalized value, a combined value, or both a normalized value and a combined value.

In some implementations, the vector calculation unit 232 stores a processed vector into the unified memory 218. In some implementations, the vector processed by the vector calculation unit 232 may be stored into the input memory 216 and then used as an active input of the operation circuit 228, for example, for use at a subsequent layer in the convolutional neural network.

The data output from the operation circuit 228 and/or the vector calculation unit 232 may be transferred to the external memory 204.

FIG. 4 is a schematic diagram of the AI model 148 in the form of a deep neural network (DNN). As shown, the DNN 148 comprises an input layer 302, a plurality of cascaded hidden layers 304, and an output layer 306. The trained AI model 148 may have a set of parameters optimized through the AI-model training.

The input layer 302 comprises a plurality of input nodes 312 for receiving input data and outputting the received data to the computation nodes 314 of the subsequent hidden layer 304. Each hidden layer 304 comprises a plurality of computation nodes 314. Each computation node 304 weights and combines the outputs of the input or computation nodes of the previous layer (that is, the input nodes 312 of the input layer 302 or the computation nodes 314 of the previous hidden layer 304, and each arrow representing a data transfer with a weight). The output layer 306 also comprises one or more output node 316, each of which combines the outputs of the computation nodes 314 of the last hidden layer 304 for generating the outputs 356.

As those skilled in the art will appreciate, the AI model such as the DNN 148 shown in FIG. 4 generally requires training for optimization. For example, a training device 146 (see FIG. 2) may provide training data 142 (which comprises a plurality of training samples with corresponding desired results) to the input nodes 312 to run through the AI model 148 and generate outputs from the output nodes 316. By comparing the outputs obtained from the output nodes 316 with the desired results in the training data 142, a lost function may be established and the parameters of the AI model 148, such as the weights thereof, may be optimized by minimizing the lost function.

### B. Training of AI Model

As described above, training an AI model such as a deep-learning model may need massive datasets which may take a long time and lead to a high memory consumption and computational complexity.

To address this issue, two different family of the methods are used in prior art to improve either the structural efficiency or the data efficiency. To improve structural efficiency, the model architecture is modified so that calculations become more efficient. In other words, the model becomes less computationally expensive. Some examples of this type of methods include network pruning, low rank decomposition, weight quantization, and the like.

On the other hand, data-efficient training methods do not change the model architecture. Rather, these methods try to increase the training speed by removing the less-important samples from the dataset. In other words, since the number of data samples controls the number of forward and backward passes during training, the training time may be reduced by reducing the number of training samples used in each training epoch.

Data-efficient training methods can be categorized into three groups including: dataset condensation, dataset pruning, and curriculum learning.

Dataset-condensation methods (see Reference [1]) synthesize a new and smaller dataset whose distribution represents the essential distributional features of the original dataset. In other words, the data samples in the new dataset may not be in the original dataset but their distribution is close to that of the full dataset. Therefore, the small dataset is not necessarily a subset of the full dataset. This could be performed by optimizing Kernel ridge-regression with respect to the input data samples. Other methods in this category include using a generator function, auxiliary small unlabeled samples, and learning soft labels on a small dataset.

In dataset-condensation methods, the new dataset has a lower number of data samples compared to the original one, and provides a significant save in the storage. This save in memory makes them suitable in scenarios involving multiple datasets or frequent dataset exchange such as federated learning.

However, dataset-condensation methods may require a preprocessing stage before the actual training phase in order to condense the dataset. As a result, although these methods provide speed-up during training of the actual network by reducing the size of dataset, they introduce an expensive condensation step before the actual training step which may lead to even worse training time in total. Therefore, the dataset-condensation methods may not be suitable for use cases with only one task or use cases where it is not preferable to train multiple networks with the same dataset.

Another disadvantage is that, in most dataset-condensation methods, the condensation needs to be performed separately for different tasks and different target networks. Moreover, the dataset-condensation methods are often based on optimizing over the input parameters involving gradient which makes them inapplicable for natural language processing (NLP) tasks dealing with discrete data samples.

Dataset-pruning methods (see Reference [2]) reduce the size of the original dataset by deleting less important and less representative data samples, which means that in contrast with the dataset-condensation methods, the new dataset is a subset of the original dataset. A metric may be used to indicate the importance of each data sample through gradient norms. A scaled-down model can also be trained as a proxy to select important data samples based on some pre-defined metric. The number of times a model misclassifies a sample can be another metric for sample importance. High variance of gradients is also observed to be a representative of example difficulty. The index of the first layer at which a k-nearest neighbors (k-NN) classifier can successfully classify an example, namely prediction depth, as a measure for computational difficulty.

Dataset-pruning methods provides save in memory storage by reducing the size of dataset. In most of these methods, the required calculations during the stage before training is less than dataset-condensation methods, which makes the dataset-pruning methods more acceptable in practice. Also, most dataset-pruning methods are based on defining metrics which can be defined for NLP datasets as well. These methods also does not require taking gradients over the input sample or generating a sample which has not been in the actual dataset. Unlike most dataset-condensation methods, dataset-pruning methods are more explainable as one can find out which samples are more important for a specific task.

However, similar to dataset-condensation methods, dataset-pruning methods do not provide overall speed-up as a preprocessing stage is required for calculating metrics, or combining samples to construct coresets. Therefore, dataset-pruning methods may only be suitable for finding a small dataset and using it several times. As most dataset-pruning methods only keep a subset of data samples without generating new data samples, they may fail to capture all characteristics of the original distribution. Moreover, some dataset-pruning methods may not be suitable for NLP tasks.

Curriculum-learning methods are based on identifying the appropriate order of data samples for an accelerated convergence (see Reference [3]). They do not remove data samples. Rather, these methods are based on the assumption that the order of data samples is important for making the model converge faster. Curriculum-learning methods define a metric to quantify the importance of a data sample, and the order of learning is based on that score. The scoring of samples is done either with human engineering or with automated metrics. While hand-crafted metrics suffer from being task-specific, they outperform automated metrics. The two metrics are still useful in several tasks. Most of the dataset reduction techniques for isolated learning or distillation primarily focus on image classification tasks with little exploration on text-based tasks.

Curriculum-learning methods usually do not require a stage before training and do not need an auxiliary network to be trained for the purpose of data efficient training. However, these techniques do not lead to save in memory as they only change the order of training samples. These methods also do not necessarily lead to speed-up in end-to-end training time.

In the following, a data-efficient training method for training AI models with training acceleration is described. Herein, “training acceleration” refers to is a technique whose goal is to train large AI models more efficiently while using less memory and computational resources. As those skilled in the art will appreciate, the data-efficient training method disclosed herein may be used alone or in combination with other training methods for speeding up the AI model training.

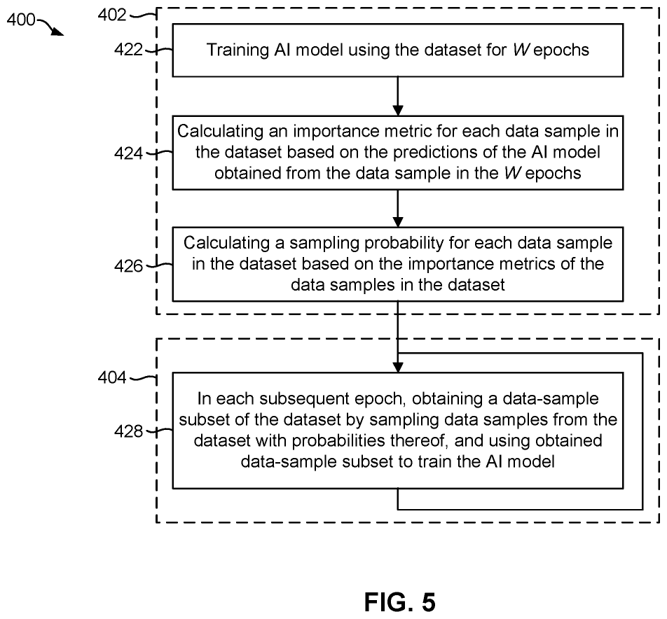

FIG. 5 is a schematic diagram showing the data-efficient training procedure 400 for training an AI model, according to some embodiments of this disclosure. As shown, the data-efficient training procedure 400 comprises a full-dataset stage 402 and a sampling stage 404.

The full-dataset stage 402 comprises steps 422, 424, and 426. At step 422, the entire training dataset is used to train the AI model (denoted “full dataset training”) for W epochs, where W≥1 is an integer. As those skilled in the art understand, an epoch is a cycle when all training data samples in the training dataset are used by the AI model for updating the parameters thereof. In each epoch, the AI model generates a prediction or inference using each data sample of the training dataset.

At step 424, an importance metric is calculated for each data sample in the training dataset based on the predictions of the AI model obtained from the data sample in the W epochs.

At step 426, a sampling probability for each data sample in the training dataset is calculated based on the importance metrics of the data samples in the training dataset.

After the W-epoch full dataset training, the AI-model training enters the sampling stage 404, wherein the AI-model training may be speed up by using a data-sample subset of the training dataset (denoted “reduced dataset training”). This speed-up is controlled by two factors: the dataset-size ratio r (r≤1) between the size (that is, the number of data samples) of the data-sample subset and that of the training dataset, and the sampling probability of each data sample in the training dataset.

The dataset-size ratio r controls the number of samples fed through the AI model. The lower the dataset-size ratio r, the less number of data samples are chosen from the training dataset. If N is the total number of data samples in the training dataset, the number of data samples of the data-sample subset that will be fed during each subsequent epoch will be Nx r. By feeding only a portion of the data-sample subset dataset, the number of forward and backward passes decreases which leads to a faster training.

The sampling stage 404 comprises step 428. At this step, the AI-model training is continued based on a data-sample subset of the training dataset. More specifically, in each subsequent epoch, a data-sample subset of the training dataset is obtained by selecting N xr data samples from the training dataset based on the sampling probabilities thereof. In other words, a data sample with a higher sampling probability is more likely to be selected than a data sample with a lower sampling probability. The data-sample subset is then used to train the AI model in this epoch.

Step 428 may be executed for one or more epochs until the AI-model training is completed (for example, the prediction of the AI model is optimized or until a predefined number of epochs are performed).

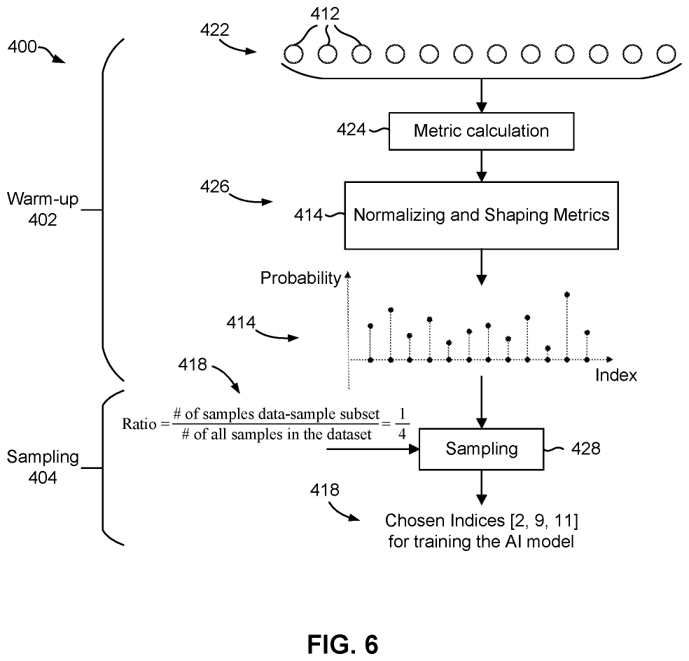

FIG. 6 is a schematic diagram showing an example of the data-efficient training procedure 400 for training a deep-learning model that uses a logit function for prediction.

The full-dataset stage 402 comprises steps 422, 424, and 426. At step 422, the entire training dataset 412 is used to train the deep-learning model for two epochs (that is, W=2). The logit function values (denoted “logits”) obtained from each data sample of the training dataset 412 in the two consecutive epochs are recorded.

In this embodiment, the 1-hop divergence of the logits (that is, the divergence of the logits between consecutive epochs) obtained from each data sample of the training dataset 412 in the two epochs is used as the importance metric. This metric shows how much alteration the model's predication has for each data sample. High alteration translates to less confidence in prediction and the system feeds those ambiguous samples more frequently into the model as those have higher metric and therefore higher probabilities of sampling. Thus, at step 424, the importance metric is calculated for each data sample in the training dataset 412 as follows:

$${( 1 - hop divergence )}_{i} = {‖ {P}_{S , i} - {P}_{( S - 1 ) , i} ‖}_{2} \qquad ( 1 )$$

where (1-hop divergence)ᵢ represents the 1-hop divergence for the i-th data sample in the dataset 412, P_{(s),i} is the logits of the deep-learning model obtained from the i-th data sample at epoch S (where S=1, . . . ) and P_{(S-1),i} is the logits of the deep-learning model obtained from the i-th data sample at the previous epoch S. This importance metric shows how the logits of the deep-learning model are changing between consecutive epochs of training.

At step 426, a sampling probability for each data sample in the training dataset 412 is calculated based on the importance metrics, that is, the 1-hop divergences of the data samples in the training dataset. In this embodiment, the sampling probability 414 for each data sample is the normalized metric calculated from the importance metric shown in Equation (1) using division by the sum of all metrics:

$$P r ( {x}_{i} ) = \frac{{( 1 - hop divergence )}_{i}}{{\sum }_{i = 1}^{N} [ {( 1 - hop divergence )}_{i} ]} \qquad ( 2 )$$

Or by a softmax function:

$$P r ( {x}_{i} ) = \frac{{e}^{σ \times {( 1 - hop divergence )}_{i}}}{{\sum }_{i = 1}^{N} {e}^{σ \times {( 1 - hop divergence )}_{i}}} \qquad ( 3 )$$

where Pr(xᵢ) represents the sampling probability of the i-th data sample xᵢ, σ is a sharpness-controlling factor which controls the sharpness of final distribution (smaller σ leads to more uniform distribution), and N is the total number of data samples in the training dataset 412.

The sampling stage 404 comprises step 428. At this step, the deep-learning model training is continued based on a data-sample subset of the training dataset 412. More specifically, in each subsequent epoch, a data-sample subset of the training dataset 412 is obtained by selecting N×r data samples from the training dataset 412 based on the sampling probabilities 414 thereof obtained using Equation (3) for i=1, . . . , N. The data-sample subset is then used to train the deep-learning model in this epoch.

Step 428 may be executed for one or more epochs until the prediction of the deep-learning model is optimized or until a predefined number of epochs are performed.

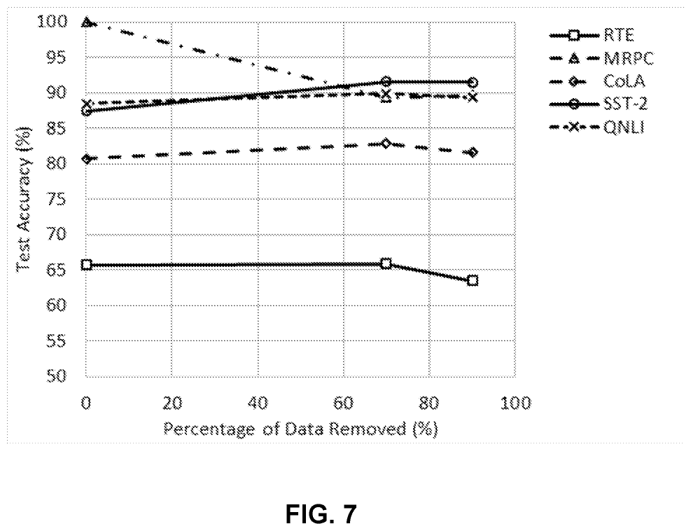

FIG. 7 is a plot showing the experiment results of the data-efficient training method 400 applied to the well-known language model called Bidirectional Encoder Representations from Transformers (BERT) developed by Google LLC, to test the effect of the data-efficient training on fine-tuning it on five different downstream tasks including Recognizing Textual Entailment (RTE), Microsoft Research Paraphrase Corpus (MRPC), Corpus of Linguistic Acceptability (CoLA), Stanford Sentiment Treebank SST-2, and Question-answering NLI (QNLI), which are benchmark tasks in the NLP area.

As those skilled in the art understand, BERT is a well-known NLP model which uses a stack of Transformer-based modules in order to transform the input text into an embedding space. It receives the input text in the form of an embedding vector and encodes them into features that may be used for a variety of down-stream tasks such as question answering, text classification, and the like.

The experiments are conducted on the Ascend 910 NPUs offered by Huawei Technologies Co., Ltd. of Shenzhen, Guangdong, China. As can be seen, the AI-model training may be completed more than three (3) times faster using only 10% of the datasets as shown in the following tables with minimal loss or improvement in accuracies.

| Dataset-Size | | | | | |
|---|---|---|---|---|---|
| Ratio r = 1 | RTE | MRPC | CoLA | SST-2 | QNLI |
| Accuracy | 65.7 | 100 | 80.7 | 87.5 | 88.5 |
| Total Training Time | 65 | 12 | 229 | 1725 | 2740 |
| Total Save in | 1.00 | 1.00 | 1.00 | 1.00 | 1.00 |
| Training Time | | | | | |

| Dataset-Size | | | | | |
|---|---|---|---|---|---|
| Ratio r = 0.3 | RTE | MRPC | CoLA | SST-2 | QNLI |
| Accuracy | 65.9 | 89.4 | 82.9 | 91.6 | 89.9 |
| Total Training Time | 31 | 6 | 100 | 781 | 1230 |
| Total Save in | 2.09 | 2.00 | 2.29 | 2.20 | 2.22 |
| Training Time | | | | | |

| Dataset-Size | | | | | |
|---|---|---|---|---|---|
| Ratio r = 0.1 | RTE | MRPC | CoLA | SST-2 | QNLI |
| Accuracy | 63.5 | 89.7 | 81.6 | 91.5 | 89.4 |
| Total Training Time | 19 | 4 | 65 | 500 | 776 |
| Total Save in | 3.42 | 3.00 | 3.52 | 3.45 | 3.53 |
| Training Time | | | | | |

In above embodiments, the dataset-ratio r is fixed for all epochs of the reduced dataset training. In some embodiments, different dataset-ratios r may be used in different epochs of the reduced dataset training.

In above embodiments, the dataset-ratio r is used for determining the size of the data-sample subset with respect to that of the dataset 412. In some embodiments, the size of the data-sample subset may be a predefined parameter such that the reduced dataset training is based on a fixed-size data-sample subset regardless how large the full training dataset is.

In above embodiments, after the first W-epoch over full dataset training, the data-sample subset is obtained from the training dataset in each subsequent epoch for training the AI model. In other words, the data-sample subsets obtained in different epochs of reduced dataset training may be different. In some other embodiments, after the first W-epoch over full dataset training, the data-sample subset is obtained from the training dataset, and the same data-sample subset is then used for all epochs of the subsequent reduced dataset training.

In other embodiments, other metrics may be used for calculating the sampling probability for each data sample. For example, in some embodiments, the entropy of the prediction may be used as the importance metric for each data sample, which is calculated as:

$${( Entropy )}_{i} = - {\sum }_{\# Classes} {P}_{S , i} log ( {P}_{S , i} ) \qquad ( 4 )$$

The sampling probability 414 for each data sample is:

$$P r ( {x}_{i} ) = \frac{{( Entropy )}_{i}}{{\sum }_{i = 1}^{N} [ {( Entropy )}_{i} ]} \qquad ( 5 )$$

Or using a softmax function as:

$$P r ( {x}_{i} ) = \frac{{e}^{σ \times {( Entropy )}_{i}}}{\sum {e}^{σ \times {( Entropy )}_{i}}} \qquad ( 6 )$$

In some embodiments, the M-hop divergence (M>1) of the output of AI model may be used as the importance metric for each data sample (the M-hop divergence may be considered a special case of the M-hop divergence with M=1), which is calculated as:

$${( M - hop divergence )}_{i} = {\sum }_{j = 0}^{M - 1} {‖ {P}_{( S - j ) , i} - {P}_{( S - j - 1 ) , i} ‖}_{2} \qquad ( 7 )$$

The sampling probability 414 for each data sample is:

$$P r ( {x}_{i} ) = \frac{{( M - hop divergence )}_{i}}{{\sum }_{i = 1}^{N} [ {( M - hop divergence )}_{i} ]} \qquad ( 8 )$$

Or using a softmax function as:

$$P r ( {x}_{i} ) = \frac{{e}^{σ \times {( M - hop divergence )}_{i}}}{{\sum }_{i = 1}^{N} {e}^{σ \times {( M - hop divergence )}_{i}}} \qquad ( 9 )$$

The importance metrics calculated in the full-dataset stage 402 may change in subsequent training. Therefore, the performance of the AI-model training in above embodiments made degrade.

In some embodiments, the importance metrics may be repeatedly (for example, periodically, or when needed (such as when the performance of the AI-model training is degraded)) reevaluated based on the predictions obtained from the data samples in the data-sample subset, for alleviating the performance-degradation issue.

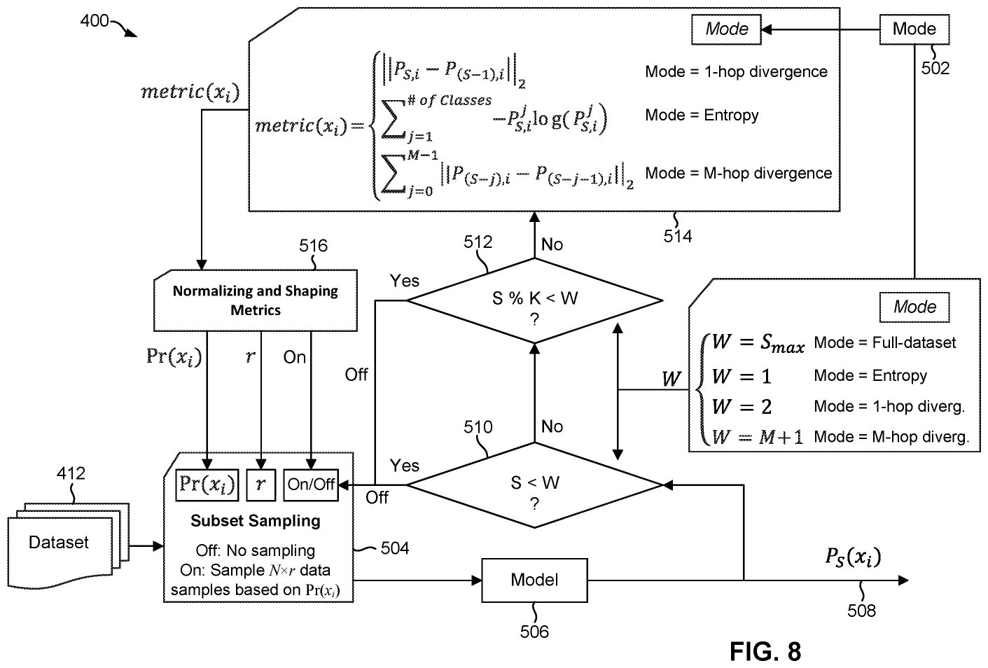

FIG. 8 is a schematic diagram showing the data-efficient training procedure 400 in these embodiments. The data-efficient training procedure 400 provides a plurality of modes and uses a mode selector 502 for selecting the mode. The selected mode determines the importance-metrics reevaluation period W, the importance-metric, and the sampling probability.

More specifically, the data-efficient training procedure 400 in these embodiments provides four modes, including:
the full-dataset mode, wherein the importance-metrics reevaluation period W equals to the total number of epochs Sₘₐₓ for training the AI model, and therefore no data sampling is used (that is, the conventional training method);
the entropy mode, wherein W=1, Equation (4) is used for calculating the importance metrics, and Equation (5) or (6) is used for calculating the sampling probability;
the 1-hop divergence mode, wherein W=2, Equation (1) is used for calculating the importance metrics, and Equation (2) or (3) is used for calculating the sampling probability; and
the M-hop divergence mode, wherein W=M+1, and Sₘₐₓ>M≥2 is an integer. Equation (7) is used for calculating the importance metrics, and Equation (8) or (9) is used for calculating the sampling probability.

After the data-efficient training procedure 400 starts, the subset-sampling module 504 is set to OFF such that no data sampling is performed and all data samples in the training dataset 412 are used for training the AI model 506 which generates the predictions 508 such as the logits Ps (xᵢ).

At step 510, the epoch number Sis checked. If Sis less than W (which is determined based on the selected mode), the data-efficient training procedure 400 goes to the subset-sampling module 504 while setting it to OFF to use all data samples in the training dataset 412 for training the AI model 506. Thus, in these embodiments, the AI-model 504 is first training for W epochs using the entire dataset 412.

Then, when at step 510, S is greater than or equal to W, the epoch number S is checked again (step 512). If S % K<W, where % represents the modulo operation, and K>0 is an integer, the data-efficient training procedure 400 goes to the subset-sampling module 504 while setting it to OFF to use all data samples in the training dataset 412 for training the AI model 506. Thus, the test at step 512 ensures W epochs of full-dataset training are performed in each K epochs.

If at step 512, S % K>W, the importance metric (which is determined based on the selected mode) is calculated (step 514). The calculated importance metric is then normalized and shaped to obtain the sampling probabilities Pr(xᵢ) for all data samples in the dataset 412 (step 516). The calculated sampling probabilities Pr(xᵢ) and the dataset-size ratio r are sent to the subset-sampling module 504 which is now set to ON for selecting N×r data samples from the training dataset 412 based on the sampling probabilities 414 thereof. The selected data subset is then used for training the AI model 506. Thus, in these embodiments, the sampling probabilities Pr(xᵢ) of the selected N×r data samples are updated every K epochs.

In above embodiments, the AI model 506 is first trained using the full dataset for W epochs. In some other embodiments, the AI model 506 is first trained using the full dataset for more than W epochs.

In some embodiments, the data-efficient training procedure 400 may only comprise one of the modes. In these embodiments, the data-efficient training procedure 400 does not comprise a mode selector 502.

In some embodiments, the importance metrics may be repeatedly (for example, periodically, or when needed (such as when the performance of the AI-model training is degraded)) re-evaluated based on the predictions obtained from the data samples in the training dataset, for alleviating or solving the performance-degradation issue. By doing that, the forward pass needs to be done for all data samples of the training dataset 412 frequently. The length of this reevaluation interval controls the save in time.

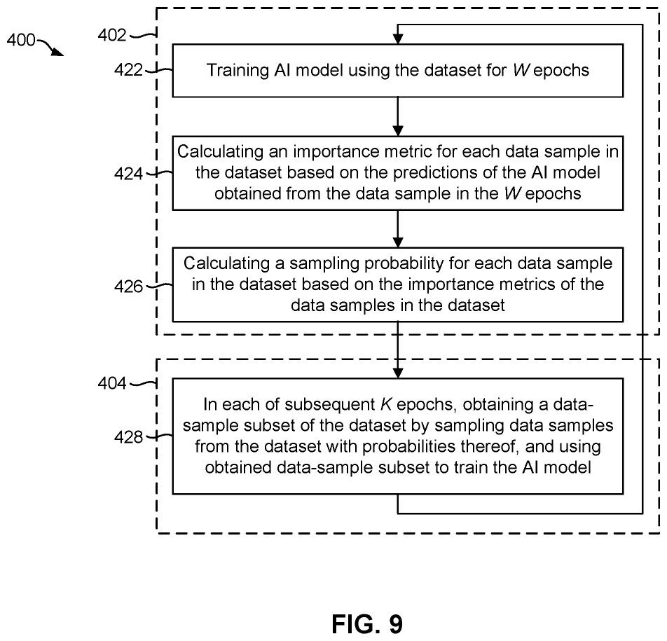

FIG. 9 is a schematic diagram showing the data-efficient training procedure 400 in these embodiments. The data-efficient training procedure 400 is similar to that shown in FIG. 5 except that, in these embodiments, the full dataset training (that is, the full-dataset stage 402) and the reduced dataset training (that is, the sampling stage 404) are alternately performed until the AI-model training is completed, wherein each time the full dataset training is performed for W epochs and the reduced dataset training is performed for K epochs. Each time after the W-epoch full dataset training, the sampling probabilities Pr(xᵢ) of all data samples in the training dataset are updated based on the predictions of the previous W epochs.

In above embodiments W is an integer. In some other embodiments, W may be a variable (for example, a certain percentage of previous epochs, a variable number of previous epochs, all previous epochs, or the like).

In some embodiments, the sampling probabilities Pr(xᵢ) of a portion of or all data samples in the training dataset may updated based on the predictions of any suitable number of previous epochs.

In some embodiments, an auxiliary model may also be used in addition to the AI model to be trained, wherein the output of the auxiliary model may be compared with that of the AI model to be trained to calculate the importance metrics of the data samples. However, these embodiments may require extra computation and memory.

The AI system 100 and the data-efficient training method 400 disclosed herein have various benefits. For example:
The full-dataset stage 402 is applied during the training of the AI model (instead of before the training). Thus, the AI model is trained in the full-dataset stage, and no pre-training stage is required. Therefore, the total training time may be significantly saved compared to prior-art dataset-condensation methods. Moreover, since the data-efficient training method 400 samples from the dataset before each epoch, the AI-model training in each epoch is accelerated.
In the sampling stage 404, no data sample is removed. Rather, all data samples of the training dataset have their chances to contribute to the training at the sampling stage 404 (but with different probability of being chosen).
The importance metrics are not task specific or hand-crafted, and may be used for training of any AI models.
The importance metrics and accordingly the sampling probabilities of data samples may be repeated updated during AI-model training as the model, thereby providing more accurate training over time.
No auxiliary network is used for calculating the importance metric. The data-efficient training method 400 only uses the difference between the outputs of the same model between consecutive epochs to measure the importance of the data samples.
The data-efficient training method 400 may be used for any suitable type of tasks including Computer Vision (CV) and NLP as the data-efficient training method 400 does not generate new samples by using gradient and other synthesizing methods.
The calculated metrics and dataset-size ratio r may be updated during training which may lead to a more accurate and flexible sampling in the next epochs. This makes the data-efficient training method 400 more flexible to perform well in different scenarios.

Among methods based on curriculum learning, the method of Reference [3] starts with a few training epochs using all data samples. During those epochs, a metric is calculated for each sample which is normalized to be used in the sampling stage. The metric is based on optimizing the dynamics of training and it is updated during each epoch for the fraction of samples chosen during that epoch by using moving average. Then, there are epochs of using whole dataset. The rate of sampling may change during training. Reference [3] shows that its method leads to having almost the same performance with fewer number of iterations and epochs.

Generally, the method of Reference [3] is different from the method disclosed herein in the following aspects:
The metrics used in the method of Reference [3] and in the method disclosed herein are different.
The method of Reference [3] uses labels of data samples in calculating the metric thereof while the method disclosed herein does not use labels in metric calculation.
The method of Reference [3] tracks the changes in learning rate while the method disclosed herein does not.
In the full-dataset stage, number of epochs is a hyperparameter in the method of Reference [3] while, in some embodiments, the method disclosed herein may use the whole dataset for the minimum number of epochs needed for the sampling stage.
The method of Reference [3] updates metrics in all epochs while, in some embodiments, the method disclosed herein may not update the metrics, or in some other embodiments, may update the metrics every K epochs (K>1).
The method of Reference [3] changes the sampling ratio r while, in some embodiments, the method disclosed herein may use a fixed sampling ratio r for the entire AI training procedure.

More specifically, Reference [3] states that its importance metric, based on which they perform sampling, leads to almost the same performance with lower number of required batches compared to uniform sampling. However, there is no guarantee on that the end-to-end execution time, which is the combination of sampling, metric calculation, updating metrics, and episodes of using the whole dataset, is decreased. In contrary, the method disclosed herein guarantees acceleration of end-to-end execution time with negligible degradation in performance compared to using the whole dataset for all epochs.

In Reference [3], updating metric of each sample in all epochs is critical as the estimate of dynamic must be up-to-date. This may limit the efficiency of sampling since it cannot be done in parallel for different epochs. However, in the method disclosed herein, the update may not be needed, and if needed, may be done in intervals. Therefore, the method disclosed herein may perform sampling in parallel for each epoch in the interval during which the metrics are not updated.

The metric calculation of Reference [3] requires knowledge about the learning dynamic and hyperparameters of the model such as learning rate, or some information about dataset such as actual labels. This may limit its application in distributed learning framework because, if sampling is performed in a centralized server, it does not have access to dynamics of users and they need to send those details to the server which increases the overhead. Moreover, in privacy preserving scenarios, there may be no access to the actual labels from user's dataset. Therefore, the metric introduced by Reference [3] is not applicable in those scenarios.

The main use case of methods based on non-handcrafted metric and sampling based on that metric is Natural Language Processing as these tasks are based on data which is discrete in the nature. Reference [3] lacks results and analysis for NLP tasks and state-of-the-art models used in NLP literature.

### C. REFERENCES

[1] Bo Zhao, Konda Reddy Mopuri, and Hakan Bilen, “Dataset condensation with gradient matching,” arXiv preprint, arXiv:2006.05929 (2020), accessible at: https://arxiv.org/abs/2006.05929.
[2] Mansheej Paul, Surya Ganguli, and Gintare Karolina Dziugaite, “Deep Learning on a Data Diet: Finding Important Examples Early in Training,” Advances in Neural Information Processing Systems 34 (2021), accessible at: https://proceedings.neurips.cc/paper/2021/hash/ac56f8fe9eea3e4a365f29f0f1957c55-Abstract.html.
[3] Tianyi Zhou, Shengjie Wang, and Jeff Bilmes, “Curriculum Learning by Optimizing Learning Dynamics,” Proceedings of The 24th International Conference on Artificial Intelligence and Statistics, PMLR 130:433-441, 2021, accessible at: https://proceedings.mlr.press/v130/zhou21a.html.

Although embodiments have been described above with reference to the accompanying drawings, those of skill in the art will appreciate that variations and modifications may be made without departing from the scope thereof as defined by the appended claims.

What is claimed is:

1. A method comprising:
(1) calculating importance metrics of a plurality of data samples based on predictions of an artificial-intelligence (AI) model obtained from the plurality of data samples in a plurality of previous training epochs without using labels of the plurality of data samples and without using a learning rate of the AI model;
(2) calculating sampling probabilities of the plurality of data samples based on the importance metrics thereof;
(3) selecting a subset of the plurality of data samples based on the sampling probabilities of the of plurality of data samples; and
(4) training the AI model using the selected subset of the plurality of data samples for one or more epochs.

2. The method of claim 1 further comprising:
repeating steps (3) and (4); or
repeating steps (1) to (4).

3. The method of claim 1, wherein the AI model is a deep-learning model; and
wherein said calculating the importance metrics of the plurality of data samples comprises:
calculating the importance metric of each data sample of the plurality of data samples based on logits of the AI model obtained from the data sample in the plurality of previous training epochs.

4. The method of claim 3, wherein the importance metric of each data sample of the plurality of data samples is a M-hop divergence of the logits of the AI model obtained from the data sample in the plurality of previous training epochs, where M≥1 is an integer.

5. The method of claim 4, wherein the sampling probability of each data sample is a normalized metric calculated from the importance metric of the data sample and shaped using a shaping function.

6. The method of claim 4, wherein the shaping function is a sharpness-controlling factor or a softmax function.

7. The method of claim 1, wherein the importance metric of each data sample is an entropy of the predictions of the AI model obtained from the data sample in the plurality of previous training epochs.

8. The method of claim 1 further comprising:
(5) training the AI model using the plurality of data samples for one or more training epochs; and
after step (5), repeating steps (1) to (4).

9. One or more processors for performing actions comprising:
(1) calculating importance metrics of a plurality of data samples based on predictions of an artificial-intelligence (AI) model obtained from the plurality of data samples in a plurality of previous training epochs without using labels of the plurality of data samples;
(2) calculating sampling probabilities of the plurality of data samples based on the importance metrics thereof;
(3) selecting a subset of the plurality of data samples based on the sampling probabilities of the of plurality of data samples; and
(4) training the AI model using the selected subset of the plurality of data samples for one or more epochs.

10. The one or more processors of claim 9, wherein the actions further comprises:
repeating steps (3) and (4); or
repeating steps (1) to (4).

11. The one or more processors of claim 9, wherein the AI model is a deep-learning model; and
wherein said calculating the importance metrics of the plurality of data samples comprises:
calculating the importance metric of each data sample of the plurality of data samples based on logits of the AI model obtained from the data sample in the plurality of previous training epochs.

12. The one or more processors of claim 11, wherein the importance metric of each data sample of the plurality of data samples is a M-hop divergence of the logits of the AI model obtained from the data sample in the plurality of previous training epochs, where M≥1 is an integer.

13. The one or more processors of claim 12, wherein the sampling probability of each data sample is a normalized metric calculated from the importance metric of the data sample and shaped using a shaping function.

14. The one or more processors of claim 13, wherein the shaping function is a sharpness-controlling factor or a softmax function.

15. The one or more processors of claim 9, wherein the importance metric of each data sample is an entropy of the predictions of the AI model obtained from the data sample in the plurality of previous training epochs.

16. The one or more processors of claim 9, wherein the actions further comprising:
(5) training the AI model using the plurality of data samples for one or more training epochs; and
after step (5), repeating steps (1) to (4).

17. One or more non-transitory computer-readable storage devices comprising computer-executable instructions, wherein the instructions, when executed, cause a processing structure to perform actions comprising:
(1) calculating importance metrics of a plurality of data samples based on predictions of an artificial-intelligence (AI) model obtained from the plurality of data samples in a plurality of previous training epochs without using labels of the plurality of data samples;
(2) calculating sampling probabilities of the plurality of data samples based on the importance metrics thereof;
(3) selecting a subset of the plurality of data samples based on the sampling probabilities of the of plurality of data samples; and
(4) training the AI model using the selected subset of the plurality of data samples for one or more epochs.

18. The one or more non-transitory computer-readable storage devices of claim 17, wherein the actions further comprising:
repeating steps (3) and (4); or
repeating steps (1) to (4).

19. The one or more non-transitory computer-readable storage devices of claim 17, wherein the AI model is a deep-learning model;
wherein said calculating the importance metrics of the plurality of data samples comprises:
calculating the importance metric of each data sample of the plurality of data samples based on logits of the AI model obtained from the data sample in the plurality of previous training epochs; and
wherein the importance metric of each data sample of the plurality of data samples is a M-hop divergence of the logits of the AI model obtained from the data sample in the plurality of previous training epochs, where M≥1 is an integer.

20. The one or more non-transitory computer-readable storage devices of claim 17, wherein the actions further comprising:
(5) training the AI model using the plurality of data samples for one or more training epochs; and
after step (5), repeating steps (1) to (4).
